(19) United States
(12) Patent Application Publication
(10) Pub. No.: US 2024/0367931 A1
(43) Pub. Date: Nov. 7, 2024

(54) MEDIA LOADING

(71) Applicant: Hewlett-Packard Development Company, L.P., Spring, TX (US)

(72) Inventors: Rafael ULACIA PORTOLES, Sant Cugat del Valles (ES); Felix RUIZ MARTINEZ, Sant Cugat del Valles (ES); Marc BENAZET BLANES, Sant Cugat del Valles (ES)

(73) Assignee: Hewlett-Packard Development Company, L.P., Spring, TX (US)

(21) Appl. No.: 18/292,795

(22) PCT Filed: Jul. 29, 2021
(86) PCT No.: PCT/US2021/043789

§ 371 Date: Jan. 26, 2024

(51) Int. Cl. B65H 9/10; B41J 11/02; B41J 13/00; B41J 13/02; B41J 13/08; B41J 13/10; B65H 9/04

(52) U.S. Cl. CPC B65H 9/106; B41J 11/02; B41J 13/0072; B41J 13/02; B41J 13/08; B41J 13/10; B65H 9/04; B65H 2551/10

(57) ABSTRACT

According to an example, a media advance mechanism may comprise a movable assembly, a fixed assembly operatively coupled to the movable assembly, and an actuator to rotate the movable assembly with respect to the fixed assembly. The movable assembly may comprise a lateral guide extending along a length of the media path and a conveyor belt oriented towards the lateral guide, wherein the conveyor belt is to move a medium towards the lateral guide.

### BACKGROUND

Media advance mechanisms are used to load media on printing systems. In some examples, a media advance mechanism may be in the form of a standalone system to be operatively connected to the printing system. In other examples, the printing system may comprise the media advance mechanism. In use, the media advance mechanism transports media from an input region to an output region.

### BRIEF DESCRIPTION OF DRAWINGS

Features of the present disclosure are illustrated by way of example and are not limited in the following figure(s), in which like numerals indicate like elements, in which:

FIG. 1 shows a bottom view of a media loading mechanism, according to an example;

FIG. 2 shows a side view of a media loading mechanism, according to an example;

FIG. 3 shows a bottom view of a media loading mechanism comprising a set of belts, according to an example;

FIG. 4 shows a cross-sectional view of a system comprising a media advance mechanism, according to an example;

FIG. 5A shows a top view of a system comprising a media advance mechanism in a first position, according to an example;

FIG. 5B shows the system of FIG. 5A with the media advance mechanism in a second position;

FIG. 6A shows a printing system comprising a set of rollers in a non-operative position, according to an example;

FIG. 6B shows the system of FIG. 6A with the set of rollers in an operative position;

FIG. 7 shows a flowchart of a method for loading media, according to an example.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Media advance mechanisms are used to load media on printing systems. In use, a media advance mechanism transports a medium loaded in an input region towards an output region of the media loading mechanism. In order to transport the medium, the media advance mechanism may comprise a media advance engine to exert a force to the medium such that the medium is moved. Examples of media advance engines comprise conveyor belts, rolling elements, vacuum systems, among others.

Media advance mechanisms may be part of a printing system or may be in the form of an external component, i.e., a standalone device. In an example, the media advance mechanism may be part of a media loading system used to load media. Due to the multiple configurations available for printing systems, the selection of a standalone device comprising the media advance mechanism (for instance, a media loading system) or a printing system comprising the media advance mechanism may be at the discretion of the user(s). As a result, users may opt for acquiring a printing system having an integrated media loading mechanism or a media loading system to be operatively connected to an additional system such as a printing system.

When performing media loading operations using a media advance mechanism, sheets of media may be received in an input region of the media advance mechanism. Such input region may correspond, for instance, with a media tray where the sheets of print medium are stacked. In other examples, the input region may correspond with an input slot where sheets of media are manually inserted by the user of the media loading mechanism. However, since some media types may have large dimensions (e.g., a media width more than 1 meter or 1.5 meters), loading a sheet of media such that the leading edge of the media is aligned with the input region can be challenging for the user. As a result, the media receipt in the input region and the subsequent transport towards the output region may result in media skew. In some examples, a media advance mechanism may be used to load media on a print apparatus corresponding to a wide-format print apparatus that prints through inkjet technology on a print medium, such as a print medium that is size A2 or larger.

In some examples, in order to correct media skew, media advance mechanisms may correct a position of a medium while the medium is moving over a platen towards the output region. To reduce the media skew, a portion of the medium such as the leading edge of the medium or the lateral of the medium may be re-oriented. As a result, a remaining portion of the medium will be oriented accordingly. In an example, a media advance mechanism may comprise lateral guides extending along a length of the platen in order to correct a position of a lateral of the medium, wherein the contact results in a re-orientation of the leading-edge of the medium. However, the correction of the media positioning while moving over the platen may be different depending on media characteristics such as the density of the medium, the width of the medium, the length of the medium, the stiffness of the medium, the grain direction of the medium, coating(s) on the medium, deformation state of the medium, among others. In some examples, environmental conditions such as ambient air humidity may have an impact in the correction of the media positioning, and hence, these conditions may be considered when correcting the position of the medium. As a result, a media positioning correction operation can involve different actions based on the characteristics of the medium being loaded.

Disclosed herein are examples of media advance mechanisms, printing systems, media loading systems, and methods which may be used to deliver media with an allowable skew in an output region. Hence, different examples of systems, and methods are described.

As used herein, the term “skew” will be used to refer to a deviation of the media with respect to a media path direction. The skew may be measured, for instance, with a skew sensor. Similarly, the term “allowable skew” will be used to refer to a maximum skew value such that the media loading operation is considered successful, i.e., a maximum deviation between an actual media direction and the media path direction. In some examples, the maximum deviation may be set as 0.5 mm/m. However, other possible values may be possible, such as 1 mm/m or 2 mm/m.

According an example, a media advance mechanism may be used to correct an orientation of a medium moving along a media path. The media advance mechanism, as explained above, may be part of a media loading system or a printing system. To correct the orientation of the medium, the media advance mechanism may be positioned adjacent to the media path such that the media advance mechanism routes the medium towards an element of the media advance mechanism. In order to enable multiple positions for the media advance mechanism, the media advance mechanism comprises a movable assembly rotatable with respect to the media path and an actuator operatively coupled to the movable assembly. In an example, the movable assembly comprises a lateral guide extending along a length of the media path and a media advance engine oriented towards the lateral guide, wherein the media advance engine is to move the media towards the lateral guide. Upon actuating the actuator, the position of the movable assembly is modified. In an example, the actuator is mechanically connected to the lateral guide via a set of gears. In other examples, the actuator is coupled to the movable assembly via a mechanical connection between a guiding pin and a guiding track. Nonetheless, alternative implementations may be possible, such as a pneumatic system to position the movable assembly.

In the examples herein, the term “media” will be used to refer to any media which may be printed on. Examples of media include paper, cardboard, wood, tin, and/or metal.

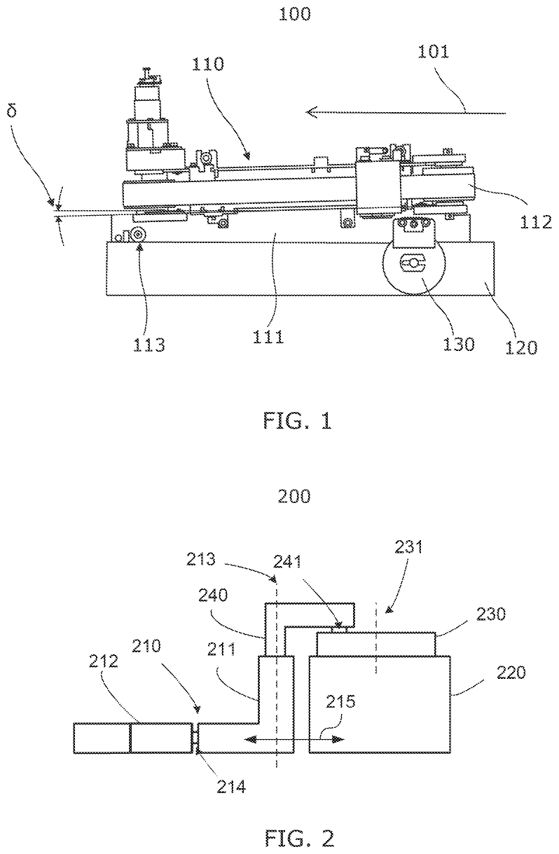

Referring now to FIG. 1, a bottom view of a media advance mechanism 100 is shown. The media advance mechanism 100 may be used to move a medium (not shown in FIG. 1) along a media path 101. While moving the medium, the media advance mechanism 100 is to correct a skew of the medium. As explained above, the media advance mechanism 100 may be positioned adjacent to a media path such that a lateral of the medium can be routed towards a lateral guide 111 of the media advance mechanism 100. As a result of the contact, an orientation of the medium along the media path 101 is modified. In FIG. 1, the media advance mechanism 100 comprises a movable assembly 110, a fixed assembly 120 operatively coupled to the movable assembly 110, and an actuator 130 to rotate the movable assembly 110 with respect to the fixed assembly 120.

In order to enable a rotation of the movable assembly 110 with respect to the fixed assembly 120, the media advance mechanism 100 comprises a pivoting element 113 mechanically connected to the movable assembly 110 and the fixed assembly 120. The movable assembly 110 comprises the lateral guide 111 extending along a length of the media path 101 and a conveyor belt 112 oriented towards the lateral guide 111. In an example, the lateral guide 111 comprises an L-shaped profile to contact a bottom side of the medium to prevent its buckling. However, alternative profiles may be implemented, such as a rectangular profile.

In the example of FIG. 1, the conveyor belt 112 is at a relative angle δ with respect to the lateral guide 111. Since the lateral guide 111 is parallel to the media path 101, the conveyor belt 112 is at the relative angle δ with respect to the media path 101. As a result of the positioning, the medium moving along the media path 101 is transported by the conveyor belt 112 towards the lateral guide 111. Then, upon contacting the lateral guide 111, the orientation of the medium with respect to the media path 101 is modified. In some examples, the relative angle θ is set such that the contact between the medium and the lateral guide 111 does not damage the medium. In the example of FIG. 1, the lateral guide 111 of the movable assembly is parallel to the media path 101. However, in other examples, the lateral guide 111 of the movable assembly 110 may be inclined with respect to the media path 101.

To operatively couple the movable assembly 110 with the fixed assembly 120, the actuator 130 of the media advance mechanism 100 may be connected to the movable assembly 110 via different types of connection. In an example, the actuator 130 may be a mechanical actuator capable of modifying a position of the movable assembly 110 with respect to the fixed assembly 120. In other examples, the movable assembly 110 may comprise a guiding pin movable along a guiding track of the actuator 130 such that the position of the movable assembly 110 is modified by adjusting a position of the guiding pin along the guiding track. In some other examples, alternative connections may be used, such as worm gear to modify a position of the movable assembly 110 or a pneumatic actuator.

Different types of media may behave different while being moved towards the lateral guide 111 of the movable assembly 110 (and the contact between the medium and the lateral guide 111 may result in different media orientations), and therefore, the usage of the actuator 130 enables a range of relative positions between the movable assembly 110 and the fixed assembly 120. Since the conveyor belt 112 is jointly coupled to the lateral guide 111, a rotation of the movable assembly 110 will result in a co-rotation of the conveyor belt 112 and the lateral guide 111 about the pivoting element 113, i.e. the lateral guide 111 and the conveyor belt 112 will remain at the relative angle δ but the movable assembly 110 and the fixed assembly 120 will be at a different angle.

Upon actuating the actuator 130, the angle between the movable assembly 110 and the fixed assembly 120 changes. To increase the correction capabilities of the media advance mechanism 100, the rotation of the movable assembly 110 with respect to the fixed assembly 120 is enabled in both a clockwise direction and a counter clockwise direction, i.e., the movable assembly 110 and the fixed assembly 120 may be positioned at both positive and negative angles. Therefore, by actuating the actuator 130, the movable assembly 110 is positioned with respect to the fixed assembly 120 without having to remove any fixing elements. In addition, due to the media orientation correction results from the contact between the medium and the lateral guide 111 of the movable assembly while the medium is moving along the media path, the throughput of the media advance mechanism 100 may be greater compared with other mechanisms which correct the media orientation when the medium is static.

In an example, the relative angle δ between the lateral guide 111 and the conveyor belt 112 is within a range from 1 to 3 degrees. However, alternative ranges may be possible based on at least one of a length of the lateral guide 111, a length of the media path 101, or media characteristics.

In some examples, the conveyor belt 112 may comprise a plurality of belt modules along the lateral guide 111. However, as previously explained, alternative media advance engines may be used, such as a set of driven rollers or a vacuum-based media advance engine.

Referring now to FIG. 2, a side view of a media advance mechanism 200 is shown. The media advance mechanism 200 comprises a movable assembly 210, a fixed assembly 220, and an actuator 230 to rotate the movable assembly 210 with respect to the fixed assembly 220. In the example of FIG. 2, the movable assembly 210 is rotatable about a rotation axis 213 defined by a pivoting element (not shown in FIG. 2). As a result of the rotation, a distal end (with respect to the rotation axis 213) of the movable assembly 210 performs a lateral movement 215 with respect to the fixed assembly 220. As previously described in FIG. 1, the movable assembly 210 comprises a lateral guide 211 and a conveyor belt 212, wherein the lateral guide 211 is attached to the conveyor belt 212 via a fixing element 214. The fixing element 214 couples the lateral guide 211 with the conveyor belt 212 at a relative position such that a medium transported by the conveyor belt 212 will be moved towards the lateral guide 211. It should be noted that, although the lateral guide 211 of the movable assembly 210 has an L-shaped profile in FIG. 2, alternative profiles may be possible, such as a rectangular profile. Nonetheless, when having the lateral guide 211 with the L-shaped profile, media advance issues such as media buckling are prevented.

In the example of FIG. 2, the actuator 230 of the media advance mechanism 200 is a knob rotatable about a rotation axis 231. To move the movable assembly 210 with respect the fixed assembly 220, the actuator 230 is attached to the fixed assembly 220 and the movable assembly further comprises an engagement element 240 coupled to the actuator 230. In FIG. 2, the engagement element 240 is mechanically connected to the lateral guide 211 and the actuator 230. In order to connect the engagement element 240 and the actuator 230, the engagement element 240 comprises a guiding pin 241 and the actuator 230 comprises a guiding track to receive the guiding pin 241. In other examples, alternative connections may be possible, such as a mechanical connection via gears, hydraulic pistons, biasing elements, among others.

To adjust a position between the movable assembly 210 and the fixed assembly 220, users have to rotate the actuator 230 either in a clockwise direction or a counterclockwise direction such that the guiding pin 241 of the engagement element 240 moves along the guiding track of the actuator 230. In an example, the guiding track may be designed such that a range of relative positions between the fixed assembly 220 and the movable assembly 210 is obtained along a range of movement of the actuator 230. In some examples, the actuator 230 may be provided with a series of physical marks such that users can set a desired position between the elements of the media advance mechanism 200. As a result of the movement of the actuator 230, the movable assembly 210 rotates about the movable assembly rotation axis 213 thereby providing the lateral movement 215 to the movable assembly 210 without having to use additional tools. In some examples, the guiding track of the actuator 230 may be a desmodromic track designed to enable a range from −0.5 degrees to +0.5 degrees between the movable assembly 210 and the fixed assembly 220.

According to an example, a conveyor belt of a media advance mechanism may comprise a set of belts in order to keep admissible tension values along a length of the movable assembly. To correct the position of the medium being moved by the belts, the set of belts may be distributed such that the belts are parallel with each other. In some examples, for each belt of the set of belts, a projection of the belt onto the lateral guide may be defined, wherein the set of belts is to be distributed such that consecutive projections are separated by a distance. By distributing the set of belts along the lateral guide, the movement of the medium towards the lateral guide of the media advance mechanism will be performed in a reliable manner and the belts included in the set of belts will not contact with each other.

According to some examples, the lateral guide of the movable assembly of the media advance mechanism comprises a first side to contact the medium and a second side remote from the media path, wherein the actuator is positioned in the second side such that, in use, the actuator is actuatable by a user.

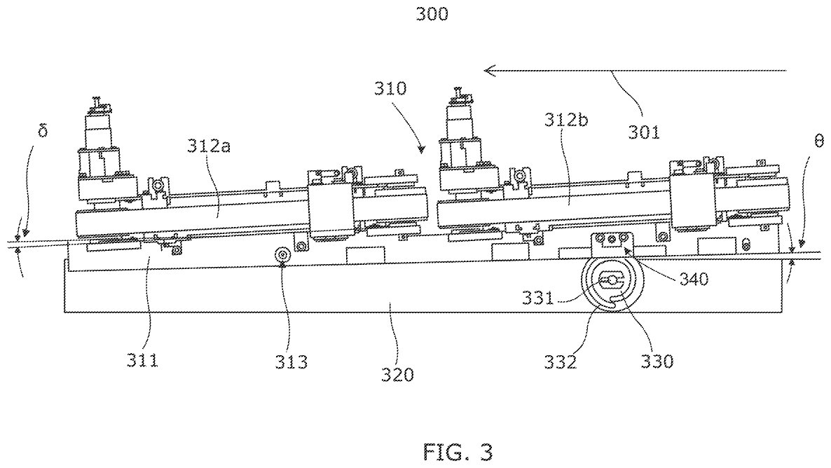

Referring now to FIG. 3, a media advance mechanism 300 comprising a set of belts is shown. The media advance mechanism 300 may be used, as previously explained, to correct a position of a medium moving along a media path 301. The media advance mechanism 300 comprises a movable assembly 310, a fixed assembly 320, and an actuator 330. The movable assembly 310 comprises a lateral guide 311 and the set of bets. In FIG. 3, the set of belts comprises a first belt 312a and a second belt 312b, wherein the belts are parallel with each other and are oriented towards the lateral guide 311. In particular, in FIG. 3, the set of belts of the movable assembly 310 is at an angle δ so that a lateral of the medium transported by the set of belts is brought into contact with the lateral guide 311. In order to avoid movement deficiencies, each of the first belt 312a and the second belt 312b are configured to have the same tension and to advance the medium at the same speed such that media deficiencies are avoided. As explained above, the set of belts are distributed such that consecutive projections onto the lateral guide 311 are separated by a distance, i.e., the first belt 312a and the second belt 312b are not contiguous.

As previously explained in reference to FIGS. 1 and 2, the movable assembly 310 is rotatably coupled to the fixed assembly 320 via a pivot element 313. In order to increase the range of movement, the pivot element 313 may be located at different positions along the movable assembly 310. For instance, in FIG. 3, the pivoting element 313 is located at a distance of an engagement element 340 that mechanically connects the movable assembly 310 and an actuator 330 attached to the fixed assembly 320. In particular, the engagement element 340 connects the lateral guide 311 of the movable assembly 310 to a desmodromic track 332 of the actuator 330. The actuator 330 is to rotate about an actuator rotation axis 331, and upon rotation, a pin portion (not shown in FIG. 3) of the engagement element 340 is to move along the desmodromic track 332 such that a relative position between the movable assembly 310 and the fixed assembly 320 is modified. In FIG. 3, the relative position between the movable assembly 310 and the fixed assembly 320 is represented by an alignment angle θ. Upon actuating the actuator 330, the alignment angle θ is modified. In order to further increase the movement capabilities, the desmodromic track 332 of the actuator 330 is capable of moving the movable assembly 310 away from the fixed assembly 320 when rotated in a first direction and moving the movable assembly 310 towards the fixed assembly 320 when rotated in a second direction. Thus, both positive values and positive values are possible for the alignment angle θ. In an example, the actuator 330 rotates the movable assembly 310 within a range from −0.5 degrees to +0.5 degrees with respect to the fixed assembly 320. In some examples, the alignment angle range may result in a movement range of a distal end of the movable assembly 310 within a range from −5 mm to +5 mm.

According to an example, the position of the movable assembly 310 and the fixed assembly 320 (i.e., the alignment angle θ) is set based on the type of medium within the media path 301. Based on a media profile associated with the medium, the actuator 330 may be rotated so that the relative position is modified without having to use additional tools to set a position of the movable assembly. For example, when correcting the media orientation of a medium with a large area density, the movable assembly 310 may be positioned differently than when with correcting the media orientation of a medium with a low area density. In an example, the position of the actuator 330 (and hence the position of the movable assembly 310 with respect to the fixed assembly 320) is based on a media profile defined by at least one of a media grain direction, dimensions of the medium, and the area density of the medium.

According to some examples, a media loading system may comprise a media advance mechanism to correct a skew of a medium. As previously explained, the skew correction results from a contact between the medium and a lateral guide of a movable assembly of a media advance mechanism, wherein the contact re-orients the medium such that the medium will output the media loading system with a corrected media orientation. Since the medium is to be routed by the set of belts towards the lateral guide of the movable assembly, the skew correction is performed while the medium is moving along a media path. To effectively correct the skew of the medium, the media advance mechanism is positioned adjacent to the media path such that the set of belts or the conveyor belt of the media advance mechanism is capable of guiding the medium towards a lateral guide of the media advance mechanism. In this fashion, the orientation of the medium will be corrected while the medium is moving along the media path, and hence, the throughput of the loading operation may be increased compared to other skew corrections method to correct the orientation of the medium when the medium is static.

According to other examples, a printing system may comprise the media loading system to correct the skew of a medium while moving from an input region to an output region. In an example, the output region of a printing system may correspond with an input region of additional stages of a printing operation, such as an input area of a printing region.

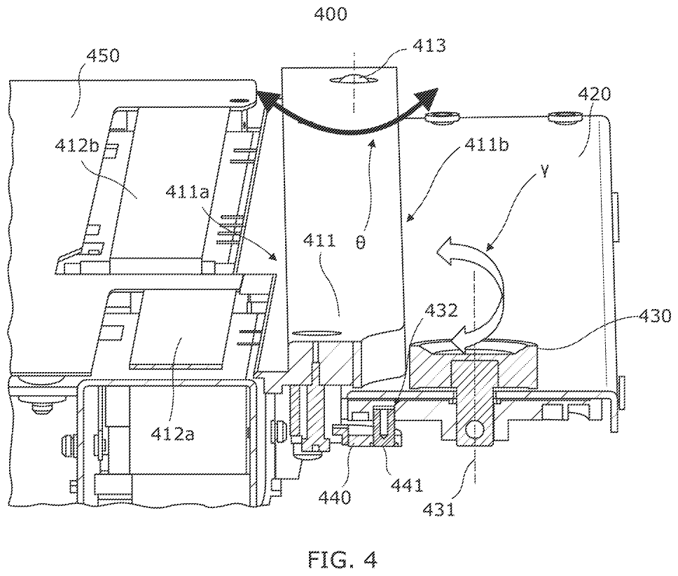

Referring now to FIG. 4, a cross-sectional view of a system 400 comprising a media advance mechanism is shown. The system 400 may correspond, for instance, with a media loading system or a printing system. The media advance mechanism comprises a movable assembly rotatable with respect to a fixed assembly 420. In particular, the movable assembly of the media advance mechanism comprises a lateral guide 411 and a set of belts that are to co-rotate about a pivoting element 413. Due to the set of belts being jointly coupled to the lateral guide 411, the rotation of the movable assembly about the pivoting element 413 does not result in a different relative position between the elements of the movable assembly (i.e., the lateral guide 411 and the set of belts).

As previously explained in reference to FIGS. 1 to 3, the set of belts of the movable assembly and the lateral guide 411 are at an angle (angle δ in FIGS. 1 and 3, not represented in FIG. 4). Because of their relative position, a medium moved by the set of belts will contact the lateral guide 411. In some examples, the angle may be set such that the contact between the medium and the lateral guide 411 of the movable assembly does not result in damage over the medium (wrinkles, for instance). Instead, the set of belts will route the medium towards the lateral guide 411 such that a lateral of the medium will contact the lateral guide, wherein the contact results in a corrected media orientation for the medium with respect to the media path while not damaging the medium.

To move the movable assembly with respect to the fixed assembly 420, the system 400 further comprises an actuator 430 attached to the fixed assembly 420. In FIG. 4, the actuator 430 corresponds with a desmodromic knob rotatable about a rotation axis 431. The desmodromic knob comprises a guiding track 432 to receive an engagement member 441 of an engagement element 440. As previously described, the engagement element 440 is to couple the movable assembly with the actuator 430 such that an actuator rotation γ results in a movable assembly rotation θ. As a result of the movable assembly rotation, an angle between the movable assembly (i.e., the lateral guide 411, the first belt 412a, and the second belt 412b) and the fixed assembly 420 is modified. Depending on the position of the actuator 430, and therefore the angle between the movable assembly and the fixed assembly 420, the medium may be delivered in an output region of the system 400 with a different corrected media orientation. As a result, the angle of the movable assembly and the fixed assembly 420 can be modified in an easy, repeatable, reliable, and quick manner. In some examples, the desmodromic knob may comprise a series of physical marks identifying relative positions for the media advance mechanism. In other examples, instead of having physical marks, an upper side of the desmodromic knob may comprise a display panel on which an angle between the movable assembly and the fixed assembly 420 is displayed. In some other examples, the display may further indicate a recommended position based on a media profile of the medium to be loaded.

In the system 400, the medium is to move over a platen 450 located in a first side 411a of the lateral guide 411, i.e., the medium is to contact the lateral guide 411 in the first side 411a. The fixed assembly 420 is located at a second side 411b of the lateral guide 411, i.e., in a side remote to the media path such that the fixed assembly is not within the media path. In addition, having the fixed assembly 420 located at the second side 411b enables to actuate the actuator 430 while the media is moving over the platen 450. In an example, the platen 450 may comprise a series of protruding idle rollers in order to reduce the friction generated by a contact between the media and the platen 450 during a movement from an input region of the system 400 to an output region.

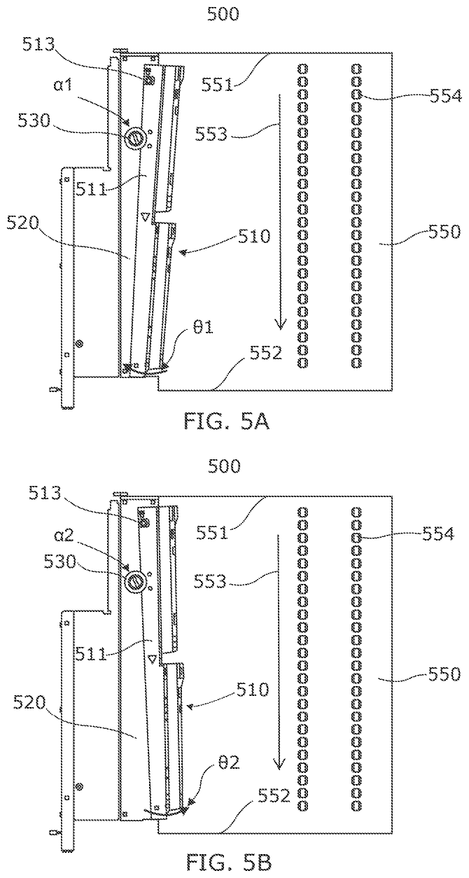

Referring now to FIG. 5A, a top view of a system 500 comprising a media advance mechanism in a first position is shown. The media advance mechanism comprises a movable assembly 510, a fixed assembly 520, and an actuator 530. The movable assembly comprises a lateral guide 511 to contact with a lateral of a medium moving over a platen 550 of the system. To transport the medium towards the lateral guide 511, the movable assembly 510 comprises a set of belts oriented towards the lateral guide 511. The system 500 is to transport the medium (not shown in FIG. 5A) from an input region 551 of the platen 550 to an output region 552 of the platen 550. While the medium is moving along a media path 553 towards the output region 552, a portion of the medium passing over a region comprising the set of belts of the movable assembly 510 will be guided towards the lateral guide 511 by the set of belts. Then, the set of belts will move the medium towards the lateral guide 511 of the movable assembly 510 such that a lateral of the medium contacts the lateral guide 511. As a result of the contact between the lateral of the medium and the lateral guide 511, a position of the medium with respect to the media path 553 will be corrected. In order to reduce the impacts of the friction forces generated while moving over the platen 550, the platen 550 of the system 500 comprises a series of idle rollers 554 protruding from the platen 550 and distributed along the media path 553.

Based on a media profile of the medium, the actuator 530 of the media advance mechanism may be positioned at a determined position such that the movable assembly 510 is at a determined angle with respect to the fixed assembly 520 (and the media path 553). For example, in the example of FIG. 5A, the actuator 530 has been rotated an angle α1 in order to position the movable assembly 510 in a first position in which the movable assembly 510 is moved towards the fixed assembly 520. In particular, the movable assembly 510 is at a negative angle θ1 with respect to the fixed assembly 520, i.e., the movable assembly 510 is oriented away from the platen 550. In an example, the negative angle θ1 may be an angle within the range of −0.5 to 0 degrees. Examples of characteristics used to define the media profile comprise at least one of a media gran direction, the dimensions of the medium, and an area density of the medium. Since media having the same media profile behave in a similar way while being transported, users may position the actuator 530 (and hence the movable assembly 510) at the same position when loading similar media.

In some examples, the system 500 may further comprise a user interface to receive input data associated with a media profile of the medium and a media advance assistant to determine a position of the actuator based on the media profile. Based on the position determined by the media advance assistant, users will obtain a recommended position for the actuator 530 such that a skew of the medium is effectively reduced while moving over the platen 550 of the system 500. In some examples, the actuator 530 may be automatically actuated based on the determination of the media advance assistant (for instance, if the actuator 530 corresponds with a pneumatic actuator, the pneumatic actuator may modify a relative position between the movable assembly 510 and the fixed assembly 520 based on the determination of the media advance assistant).

Referring now to FIG. 5B, a top view of the system 500 of FIG. 5A with the media assembly 510 in a second position is shown. In the second position, the movable assembly 510 is at a positive angle θ2 with respect to the fixed assembly 520 of the media advance mechanism, i.e., the movable assembly 510 is oriented towards the platen 550. In order to set movable assembly 510 at the positive angle θ2, the actuator 530 is rotated an angle α2. Due to the second position of the movable assembly 510 is different to the first position of the movable assembly 510 of FIG. 5A, a medium moving along a media path 553 over the platen 550 will be transported to the output region 552 of the system in a different way. In particular, two sheets of media having the same media profile may have a different position when delivered to the output region 552 when the system 500 is in the first position and when the system 500 is in the second position.

In some examples, the positive angle θ2 may be in a range from 0 degrees to +0.5 degrees. Based on the position of the actuator 530, users may adjust a position of the movable assembly 510 with respect to the fixed assembly 520. As previously explained, in order to bring the medium into contact with the lateral guide 511 of the movable assembly 510, the set of belts of the movable assembly 510 are positioned at a relative angle with respect to the lateral guide 511. In an example, the relative angle is within a range from 1 to 3 degrees.

In other examples, for each belt of the set of belts of the movable assembly 510, a projection of the belt onto the lateral guide 511 may be defined and the set of belts may be distributed such that consecutive projections are separated by a distance, i.e., the belts of the set of belts are not contiguous. Due to the separation between consecutive projections, the differences in the tensions and/or speeds of the belts will not result in a negative impact over the medium while being transported towards the lateral guide 511.

In some other examples, the system 500 may comprise a second set of idle rollers distributed along a length of the lateral guide 511, wherein the second set of idle rollers is movable between a first position in which the second set of idle rollers face the platen 550 and a second position in which the second set of rollers are above the fixed assembly 520 such that the medium will be nipped between the second set of idle rollers and the set of belts. In an example, the second set of rollers may be within a pressing assembly movable within an operative position corresponding with the first position and a non-operative position corresponding with the second position.

According to some examples, a printing system may comprise a media advance mechanism to correct a position of a medium moving along a media path. The printing system may comprise a loading region on which a medium is received. However, since the medium may be loaded on the printing system with a skew, the movement along the media path will result in an increase of the skew which may lead to deficiencies such as media jam, wrong alignment that will result in printing deficiencies, appearance of wrinkles on the medium, among others. In order to correct a position of the medium such that the medium has an allowable skew when reaching an output region, media advance mechanisms may be used.

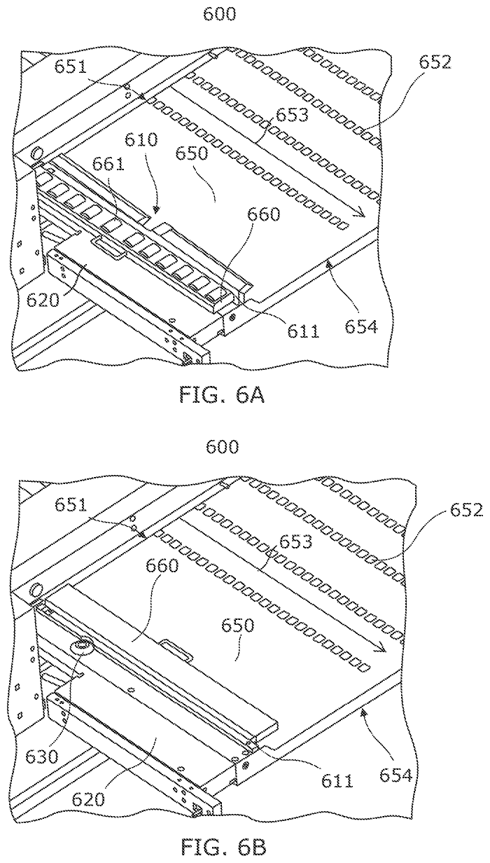

Referring now to FIG. 6A, a printing system 600 comprising a pressing assembly 660 in a non-operative position is shown. The printing system 600 comprises a loading region 651 to receive a medium, a platen 650, and a media advance mechanism to correct a skew of a medium while moving over a platen 650 along a media path 653. In FIG. 6A, the media advance mechanism extends along a length of the platen 650. In the non-operative position, a set of rollers 661 of the pressing assembly 660 is positioned above a fixed assembly 620 of the media advance mechanism, i.e., remote from the media path 653. The platen 650 of the system 600 comprises a series of protruding idle rollers 652 to contact a lower side of a medium moving over the platen 650. The media advance mechanism comprises a movable assembly 610, the fixed assembly 620, and an actuator (not shown in FIG. 6A) to modify a relative position of the movable assembly 610 with respect to the fixed assembly 620. The movable assembly 610 comprises a set of belts jointly coupled to a lateral guide 611 such that the set of belts are at a relative angle with respect to the lateral guide 611. In order to enable the movement capabilities of the movable assembly 610, the movable assembly 610 is rotatable about a pivoting element (not shown in FIG. 6) of the printing system 600. In an example, the pivoting element may be attached to the platen 650. However, in other examples, alternative locations may be possible, such as the pivoting element being attached to the fixed assembly 620.

In use, the printing system 600 receives the medium in a loading region 651. Then, upon the medium moves over a region of the system 600 comprising the set of belts of the movable assembly 610, the set of belts transports the media towards the lateral guide 611. Due to the set of protruding idle rollers 652 reduce the friction forces between the medium and the platen 650 while moving along the media path 653, the medium will be brought into contact with the lateral guide 611, thereby modifying a position of the medium while the medium moves over the platen 650 (i.e., on the fly). Then, the medium will reach an output region 654 of the platen 650 with a corrected position.

In the example of FIG. 6A, the pressing assembly 660 is in the non-operative position. In the non-operative position, the set of rollers do not contact an upper side of a medium moving over the set of belts of the movable assembly 610. As previously explained, the set of rollers 661 and the set of belts are to contact opposite sides of the medium in an operative position of pressing assembly 660.

Referring now to FIG. 6B, the printing system 600 of FIG. 6A with the pressing assembly 660 in the operative position is shown. In the operative position, the set of rollers of the pressing assembly 660 face the set of belts of the movable assembly. Due to the pressing assembly 660 is mechanically coupled to the movable assembly of the media advance mechanism, a rotation of the movable assembly will result in a rotation of the pressing assembly 660. In order to rotate the movable assembly and the pressing assembly 660, users may actuate an actuator 630 of the media advance mechanism. As previously explained, the set of rollers of the pressing assembly 660 are rotatable about rotation axes perpendicular to the lateral guide 611 of the media advance mechanism. In FIG. 6B, a medium loaded on the loading region 651 is to be nipped between the set of rollers of the pressing assembly 660 and the set of belts of the movable assembly. Then, since the set of belts and the lateral guide 611 are at a relative angle, the medium will be transported towards the lateral guide 611 thereby causing a lateral of the medium to modify its orientation with respect to the media path 653. Based on the media profile, the movable assembly of the media advance mechanism may be positioned at different positions with respect to the fixed assembly 620 by using the actuator 630. In FIG. 6B, the actuator 630 is located at a side of the lateral guide 611 remote from the media path 653. However, in other examples, the actuator 630 may be located at a different position such that the position of the media advance mechanism can be modified while a medium is moving over the platen 650 of the printing system 600.

In the printing system 600 of FIG. 6, the usage of the pressing assembly 660 in the operative position ensures that the media is effectively conveyed by the set of belts towards the lateral guide 611 of the movable assembly 610 such that the contact between the medium and the set of belts does not result in media slippage. Nonetheless, in some examples, the medium may comprise a media profile which enables the media advance mechanism to correct a position of the media while being in the non-operative position, for example a medium having an area density value greater than an area density threshold value, a medium having a roughness value greater than a roughness threshold value, or a stiffness degree. In other examples, the media profile may further comprise additional information related to environmental conditions within the printing system 600 (such as ambient air humidity on a region of the platen 650), a coating on a surface of the medium, the electric charge of the medium, and the deformation state of the medium (for instance, if the medium to be transported is deformed).

In some examples, the selection of at least one of the position of the pressing assembly 660 and the position of the media advance mechanism may be based on a media profile associated to the loaded media. For example, when having a medium with an area density value lower than an area density threshold value, users may have to use the pressing assembly 660 in the operative position in order to exert a force towards the medium such that the media slippage between the medium and the set of belts is prevented. Similarly, based on the media profile, the movable assembly of the media advance mechanism may be positioned at an orientation angle with respect to the fixed assembly. For instance, when loading wider media, the actuator 630 may be positioned at a position associated with an appropriate orientation for the movable assembly.

In some other examples, the printing system 600 of FIGS. 6A and 6B may further comprise a user interface to receive input data associated with a media profile and a media advance assistant to determine a position of the actuator 630 based on the media profile. As previously explained in reference to other examples, the media profile may comprise information about at least one of a media grain direction, dimensions of the medium, an area density of the medium, among others. In an example, in order to determine the position of the actuator based on the media profile, the media advance assistant may use look-up tables including a series of positions for a series of media profile characteristics. In some other examples, the actuator 630 may be automatically actuated based on the position determined by the media advance assistant. Similarly, the media advance assistant may control the pressing assembly 660 to move to the operative position or the non-operative position based on the input data received by the user interface.

According to some examples, a method to load media using a system comprising a media advance mechanism comprises positioning a movable assembly of the media advance mechanism at a position such that a media orientation is corrected, receiving media in an output region of the system, moving the media towards a lateral guide of the media advance mechanism using a set of belts of the media advance mechanism, and outputting the media with the corrected media orientation in an output region of the system. In some examples, the method may further comprise receiving input data associated with a media profile via a user interface of the system and determining, with a media advance assistant, a position of the actuator to efficiently correct the media orientation. In an example, the media advance assistant may use look-up tables in order to determine the position of the actuator such that the movable assembly will efficiently correct the media orientation. In other examples, when the system comprises a pressing assembly, the method may further comprise moving the pressing assembly to the operative position based on the input data received by the user interface.

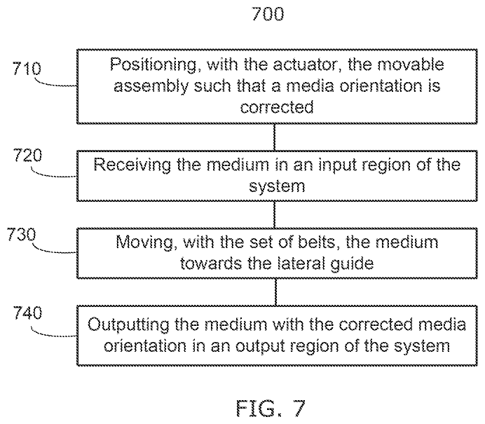

Referring now to FIG. 7, a method 700 to load a medium using a system comprising an actuator to position a movable assembly is shown. As previously described, the movable assembly comprises a set of belts oriented towards a lateral guide. At block 710, method 700 comprises positioning, with the actuator, the movable assembly such that a media orientation is corrected. In an example, position with the actuator the movable assembly may comprise rotating the actuator such that the movable assembly rotates with respect to a media path of the medium. Then, at block 720, method 700 comprises receiving the medium in an input region of the system. Upon the medium is received in the input region of the system, a portion of the medium will be over a region of the system including the set of belts. At block 730, method 700 comprises moving, with the set of belts, the medium towards the lateral guide of the movable assembly. Due to the set of belts and the lateral guide of the movable assembly are at a relative position, the movement of the medium towards the lateral guide will result in a contact between the medium and the lateral guide. In particular, a lateral of the medium will contact the lateral guide and the contact will result in the media orientation correction. Then, at block 740, method 700 comprises outputting the medium with the corrected media orientation in an output region of the system.

In some examples, the actuator of the system may comprise a desmodromic track and the lateral guide may comprise a guiding pin to move along the desmodromic track, wherein positioning the movable assembly such that the media orientation is corrected (block 710) comprises rotating the actuator such that the guiding pin moves along the desmodromic track.

In some other examples, the method may further comprise receiving an input associated with a media profile for the medium via a user interface of the system and determining, with a media advance assistant, a position of the actuator based on the input. In an example, the determination may comprise using a look-up table to determine a position of the actuator based on the input. In an example, the method may further comprise actuating the actuator based on the determination of the media advance assistant, i.e., the actuator will be actuated to the determined position based on an output of the media advance assistant.

In further examples, the method may further comprise moving a pressing assembly of the system to an operative position based on an input associated with a media profile for the medium. Based on the media profile of the medium, the pressing assembly may be moved to the operative position or may be maintained in the non-operative position.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

What is claimed is:

1. A media advance mechanism to move a medium along a media path, the mechanism comprising:
a movable assembly comprising:
a lateral guide extending along a length of the media path; and
a conveyor belt oriented towards the lateral guide, wherein the conveyor belt is to move the medium towards the lateral guide,
a fixed assembly operatively coupled to the movable assembly; and
an actuator to rotate the movable assembly with respect to the fixed assembly.

2. The media advance mechanism of claim 1, wherein the conveyor belt comprises a plurality of belt modules along the lateral guide.

3. The media advance mechanism of claim 2, wherein each of the belt modules are at an angle with respect to the lateral guide, wherein the angle is within a range from 1 to 3 degrees.

4. The media advance mechanism of claim 1, the movable assembly further comprising a set of rollers having rotation axes perpendicular to the lateral guide, wherein the conveyor belt and the set of rollers are to contact opposite sides of the medium.

5. The media advance mechanism of claim 1, wherein:
the actuator comprises a guiding track,
the movable assembly comprises a guiding pin to move along the guiding track, and
upon actuation of the actuator, the movable assembly is to rotate about the pivoting element.

6. The media advance mechanism of claim 1, wherein lateral guide comprises a first side to contact the medium and a second side remote from the media path, wherein the actuator is positioned in the second side such that, in use, the actuator is actuatable by a user.

7. A printing system comprising:
a loading region to receive a medium;
a platen comprising:
a pivoting element; and
a series of protruding idle rollers to contact the medium; and
a media advance mechanism adjacent to the platen, wherein the media advance mechanism comprises:
a lateral guide extending along a length of the platen, wherein the lateral guide is rotatable about the pivoting element;
a set of belts jointly coupled to the lateral guide, wherein the set of belts move the medium towards the lateral guide;
a fixed assembly operatively coupled to the movable assembly; and
an actuator to rotate the lateral guide with respect to the fixed assembly,
wherein the media advance mechanism is to modify a position of the medium while the medium moves over the platen.

8. The printing system of claim 7, wherein:
for each belt of the set of belts, a projection of the belt onto the lateral guide is defined, and
the set of belts is distributed such that consecutive projections are separated by a distance.

9. The printing system of claim 7, further comprising:
a user interface to receive input data associated with a media profile; and
a media advance assistant to determine a position of the actuator based on the media profile,
wherein the media profile comprises information related to at least one of a media grain direction, dimensions of the medium, and an area density of the medium.

10. The printing system of claim 9, wherein the actuator is to modify the position of the lateral guide based on the determined position.

11. The media loading system of claim 7, wherein the media advance mechanism further comprises a second set of idle rollers distributed along a length of the lateral guide, wherein the second set of idle rollers is movable between a first position in which the second set of idle rollers face the platen and a second position in which the second set of rollers are above the fixed assembly.

12. The media loading system of claim 7, wherein:
the lateral guide comprises a guiding pin,
the actuator comprises a desmodromic track, and
upon actuation of the actuator, the guiding pin moves along the desmodromic track.

13. The printing system of claim 12, wherein the actuator rotates the lateral guide within a range from −0.5 degrees to +0.5 degrees.

14. A method to load a medium using a system comprising an actuator to position a movable assembly comprising a set of belts oriented towards a lateral guide, the method comprising:
positioning, with the actuator, the movable assembly such that a media orientation is corrected;
receiving the medium in an input region of the system;
moving, with the set of belts, the medium towards the lateral guide; and
outputting the medium with the corrected media orientation in an output region of the system.

15. The method of claim 14, wherein the actuator comprises a desmodromic track and the lateral guide comprises a guiding pin to move along the desmodromic track, wherein positioning the movable assembly such that the media orientation is corrected comprises rotating the actuator such that the guiding pin moves along the desmodromic track.
